(19) United States
(12) Patent Application Publication
(10) Pub. No.: US 2025/0252555 A1
(43) Pub. Date: Aug. 7, 2025

(54) INSPECTION DEVICE AND INSPECTION METHOD USING THE SAME

(71) Applicant: Samsung Display Co., Ltd., Yongin-si (KR)

(72) Inventors: BYEONGJUN LEE, Yongin-si (KR); JAESIK KIM, Yongin-si (KR); JUNGHAN SEO, Yongin-si (KR); WOO YONG SUNG, Yongin-si (KR); KWANHYUCK YOON, Yongin-si (KR); SEUNGHO YOON, Yongin-si (KR); HYEMIN LEE, Yongin-si (KR); SEUNGGUN CHAE, Yongin-si (KR)

(73) Assignee: Samsung Display Co., Ltd., Yongin-si, Gyeonggi-do (KR)

(21) Appl. No.: 18/960,362

(22) Filed: Nov. 26, 2024

(30) Foreign Application Priority Data
Feb. 1, 2024 (KR) 10-2024-0015698

(51) Int. Cl. G06T 7/00

(52) U.S. Cl. CPC G06T 7/001; G06T 2207/20084

(57) ABSTRACT

An inspection device includes a data converter, a neural network processor, and a detector. The data converter is configured to receive an inspection image of an inspection object, convert the inspection image into grayscale data, and use the grayscale data to generate inspection data corresponding to an average brightness value of the inspection image. The neural network processor is configured to generate reference data corresponding to average brightness values of reference images of reference objects through an artificial neural network. The detector is configured to determine whether the inspection object is defective based on a comparison of the inspection data with the reference data.

### CROSS-REFERENCE TO RELATED APPLICATION(S)

This U.S. non-provisional patent application claims priority to and the benefits of Korean Patent Application No. 10-2024-0015698, under 35 U.S.C. § 119, filed in the Korean Patent Intellectual Property Office on Feb. 1, 2024, the entire contents of which are hereby incorporated by reference.

### BACKGROUND

### 1. Technical Field

The disclosure generally relates to an inspection device with improved reliability, and an inspection method using the same.

### 2. Description of the Related Art

Optical patterns, color filters, and light emitting layers of display panels may be formed using spray devices. For example, a spray device may spray, onto a target substrate, one or more inks including at least one base material and one or more particles dispersed in the base material(s) to form components constituting a display panel.

With regard to the spray devices, research on methods for analyzing defects of the spray devices is variously attempted.

The background provided herein is for the purpose of generally presenting the context of the disclosure. Work of the presently named inventors, to the extent that it is described in this background section, as well as aspects of the description that may not otherwise qualify as prior art at the time of filing, are neither expressly nor impliedly admitted as prior art against the disclosure.

### SUMMARY

Some aspects are capable of providing an inspection device for inspecting whether an inspection object (such as an object being or including a nozzle) is defective.

Some aspects are capable of providing an inspection method using an inspection device for inspecting whether an inspection object (such as an object being or including a nozzle) is defective.

Additional aspects will be set forth in the detailed description, which follows, and in part, will be apparent from the disclosure, or may be learned by practice of the disclosed embodiments and/or the claimed subject matter.

According to an embodiment, an inspection device includes a data converter, a neural network processor, and a detector. The data converter is configured to receive an inspection image of an inspection object, convert the inspection image into grayscale data, and use the grayscale data to generate inspection data corresponding to an average brightness value of the inspection image. The neural network processor is configured to generate reference data corresponding to average brightness values of reference images of reference objects through an artificial neural network. The detector is configured to determine whether the inspection object is defective based on a comparison of the inspection data with the reference data.

In an embodiment, the neural network processor may be configured to generate, through the artificial neural network, the reference data by learning a correlation between a first factor and a second factor. The first factor may include a number of times of blotting of the reference objects. The second factor may include the average brightness values of the reference images.

In an embodiment, each of the average brightness values of the reference images may be proportional to the number of times of blotting of a corresponding reference object among the reference objects.

In an embodiment, the reference data may include first data and second data categorized based on one or more reference average brightness values.

In an embodiment, the detector may be configured to determine that the inspection object is defective based on the inspection data being in a range of the second data and outside a range of the first data.

In an embodiment, each of the inspection object and the reference objects may include a nozzle. Each of the inspection image and the reference images may be a cross-sectional image of a corresponding nozzle among the nozzles of the inspection object and the reference objects.

In an embodiment, the inspection image may include a first portion at which the nozzle of the inspection object is worn down, and a second portion at which the nozzle of the inspection object is not worn down.

In an embodiment, an average brightness value of the first portion may be greater than an average brightness value of the second portion.

In an embodiment, the inspection device may further include an imaging device. The imaging device may be configured to non-destructively image a cross-section of the inspection object to generate the inspection image and to transmit the inspection image to the data converter.

In an embodiment, the first factor may further include ejection accuracy of the nozzles of the reference objects, ejection amounts of a sprayed material from the nozzles of the reference objects, and ejection rates of the sprayed material from the nozzles of the reference objects.

In an embodiment, the artificial neural network is an unsupervised artificial neural network.

According to an embodiment, an inspection method includes generating, using an artificial neural network, reference data corresponding to average brightness values of reference images of reference objects, receiving an inspection image of an inspection object, converting the inspection image into grayscale data, generating, using the grayscale data, inspection data corresponding to an average brightness value of the inspection image, and determining whether the inspection object is defective based on a comparison of the inspection data with the reference data.

In an embodiment, generating the reference data may include learning each of a first factor including a number of times of blotting of the reference objects, a second factor including the average brightness values of the reference images, and a correlation between the first factor and the second factor. The generating of the reference data may further include categorizing the reference data into at least first data and second data based on one or more reference average brightness values.

In an embodiment, generating the reference data may further include excluding invalid data not categorized as part of the first data nor the second data.

In an embodiment, each of the average brightness values of the reference images may be proportional to the number of times of blotting of a corresponding reference object among the reference objects.

In an embodiment, generating the reference data may further include evaluating accuracy of learning each of the average brightness values of the reference images, the number of times of blotting of the reference objects, and the correlation between the first factor and the second factor based on a result of the determining.

In an embodiment, each of the reference objects may be a nozzle, each of the reference images may be a cross-sectional image of a corresponding nozzle among the nozzles, and the first factor may further include ejection accuracy of the nozzles, ejection amounts of a sprayed material from the nozzles, and ejection rates of the sprayed material from the nozzles.

In an embodiment, generating the reference data may further include relearning the first factor, the second factor, and the correlation utilizing a result of the evaluating.

In an embodiment, determining that the inspection object is defective may include determining that the inspection data is in a range of the second data and outside a range of the first data.

In an embodiment, the learning may be unsupervised learning.

The foregoing general description and the following detailed description are illustrative and explanatory and are intended to provide further explanation of the claimed subject matter.

### BRIEF DESCRIPTION OF THE FIGURES

Various embodiments disclosed herein are illustrated by way of example, and not by way of limitation, in the figures of the accompanying drawings, in which like reference numerals and/or characters refer to similar elements.

FIG. 1 is a schematic block diagram of an inspection device according to an embodiment.

FIG. 2 is a schematic plan view illustrating a spray device according to an embodiment.

FIG. 3A is a schematic cross-sectional view illustrating a spray portion, which is a part of the spray device schematically illustrated in FIG. 2, and a blotter that blots the spray portion according to an embodiment.

FIG. 3B is a schematic cross-sectional view illustrating a portion to be blotted of a spray portion according to an embodiment.

FIGS. 4A and 4B are views illustrating a degree of damage to a nozzle according to a number of times of blotting according to some embodiments.

FIG. 5 is a graph illustrating reference data according to some embodiments.

FIG. 6A is a schematic view illustrating a first inspection image according to an embodiment.

FIG. 6B is a schematic view illustrating a second inspection image according to an embodiment.

FIGS. 7, 8, and 9 are flowcharts of an inspection method according to some embodiments.

### DETAILED DESCRIPTION OF THE EMBODIMENTS

In the following description, for the purposes of explanation, numerous specific details are set forth to provide a thorough understanding of various embodiments or implementations. The terms “embodiments” and “implementations” may be used interchangeably to describe one or more non-limiting examples of systems, apparatuses, methods, etc., described herein. It is apparent, however, that various embodiments may be practiced without these specific details or with one or more equivalent arrangements. In other instances, known structures and devices are shown in block diagram form to avoid unnecessarily obscuring various embodiments. Further, various embodiments may be different, but do not have to be exclusive. For example, specific shapes, configurations, and characteristics of an embodiment may be used or implemented in another embodiment without departing from the teachings of the disclosure.

Unless otherwise specified, the illustrated embodiments are to be understood as providing example features of varying detail of some embodiments. Thus, unless otherwise specified, the features, components, modules, layers, films, regions, aspects, structures, etc. (hereinafter individually or collectively referred to as an “element” or “elements”), of the various illustrations may be otherwise combined, separated, interchanged, and/or rearranged without departing from the teachings of the disclosure.

The use of cross-hatching and/or shading in the accompanying drawings is generally provided to clarify boundaries between adjacent elements. As such, neither the presence nor the absence of cross-hatching or shading is intended to convey or indicate any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. As such, the sizes and relative sizes of the respective elements are not necessarily limited to the sizes and relative sizes shown in the drawings. In a case that an embodiment may be implemented differently, a specific process order may be performed differently from the described order. For example, two consecutively described processes may be performed substantially at the same time or performed in an order opposite the described order. Also, like reference numerals and/or reference characters denote like elements.

In a case that an element, such as a layer, is referred to as being “on,” “over,” “connected to (or with),” or “coupled to (or with)” another element, it may be directly on, directly over, directly connected to (or with), or directly coupled to (or with) the other element or at least one intervening element may be present. However, in a case that an element is referred to as being “directly on,” “directly over,” “directly connected to (or with),” or “directly coupled to (or with)” another element, there are no intervening elements present. Other terms and/or phrases, if used herein, to describe a relationship between elements should be interpreted in a like fashion, such as “between” versus “directly between,” “adjacent” versus “directly adjacent,” “on” versus “directly on,” “contacting” versus “directly contacting,” “touching” versus “directly touching,” etc. Further, the term “connected” may refer to physical, electrical, and/or fluid connection. To this end, for the purposes of this disclosure, the phrase “fluidically connected” may be used with respect to volumes, plenums, holes, openings, etc., that may be connected to one another, either directly or via one or more intervening components or volumes, to form a fluidic connection, similar to how the phrase “electrically connected” is used with respect to components that are connected to form an electric connection.

For the purposes of this disclosure, a first axis extending along a first direction DR1, a second axis extending along a second direction DR2, and a third axis extending along a third direction DR3 are not limited to three axes of a rectangular coordinate system, such as x, y, and z axes of a Cartesian coordinate system, and may be interpreted in a broader sense. For example, the first axis, the second axis, and the third axis may be perpendicular to one another, or may represent different directions that are not perpendicular to one another. Further, if used herein, the phrases “at least one of X, Y, . . . , and Z” and “at least one selected from the group consisting of X, Y, . . . , and Z” may be construed as X only, Y only, . . . , Z only, or any combination of two or more of X, Y, . . . , and Z, such as, for instance, XYZ, XYY, YZ, and ZZ. Also, if used herein, the term “and/or” includes any and all combinations of one or more of the associated listed items.

Although the terms “first,” “second,” “third,” etc., may be used herein to describe various elements, these elements should not be limited by these terms. These terms are used to distinguish one element from another element. Thus, a first element discussed below could be termed a second element without departing from the teachings of the disclosure. To this end, use of such identifiers, e.g., “a first element,” should not be read as suggesting, implicitly or inherently, that there is necessarily another instance, e.g., “a second element.”

Spatially relative terms, such as “beneath,” “below,” “under,” “lower,” “above,” “upper,” “over,” “higher,” “side” (e.g., as in “sidewall”), and the like, may be used herein for descriptive purposes, and thereby, to describe one element's spatial relationship to at least one other element as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” or “over” the other elements or features. Thus, the term “below” can encompass both an orientation of above and below. Furthermore, the apparatus may be otherwise oriented (e.g., rotated 90 degrees or at other orientations), and as such, the spatially relative descriptors used herein interpreted accordingly.

The terminology used herein is for the purpose of describing some embodiments and is not intended to be limiting. As used herein, the singular forms, “a,” “an,” and “the” are intended to include the plural forms as well, unless the context clearly indicates otherwise. It is to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in and of itself, as necessarily encompassing a plurality of items—it is to be understood that a set or a subset can encompass only one member or multiple members (unless the context indicates otherwise).

The terms “comprises,” “comprising,” “includes,” “including,” “has,” “have,” and/or “having” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” “approximately,” and other similar terms, are used as terms of approximation and not as terms of degree, and as such, are utilized to account for inherent deviations in measured, calculated, and/or provided values that would be recognized by one of ordinary skill in the art. Accordingly, the term “substantially,” if used herein, and unless otherwise specified, may mean within 5% of a referenced value. For example, substantially perpendicular may mean within +5% of being parallel. Moreover, the term “between,” if used herein in association with a range of values, is to be understood, unless otherwise indicated, as being inclusive of the start and end values of the range. For example, between 1 and 5 is to be understood as being inclusive of the numbers 1, 2, 3, 4, and 5, not just the numbers 2, 3, and 4.

Various embodiments are described herein with reference to sectional views, isometric views, perspective views, orthographic views, and/or exploded illustrations that are schematic depictions of idealized embodiments and/or intermediate structures. As such, variations from the shapes of the illustrations because of, for example, manufacturing techniques and/or tolerances, are to be expected. Thus, embodiments disclosed herein should not be construed as limited to the particular illustrated shapes of regions, but are to include deviations in shapes that result from, for instance, manufacturing. To this end, regions illustrated in the drawings may be schematic in nature and shapes of these regions may not reflect the actual shapes of regions of a device, and as such, are not intended to be limiting.

As customary in the field, some embodiments may be described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the disclosure. Further, the blocks, units, and/or modules of some embodiments may be physically combined into more complex blocks, units, and/or modules without departing from the scope of the disclosure.

Unless otherwise defined, all terms (including technical and scientific terms) used herein have the same meaning as commonly understood by one of ordinary skill in the art to which this disclosure pertains. Terms, such as those defined in commonly used dictionaries, should be interpreted as having a meaning that is consistent with their meaning in the context of the relevant art and are not to be interpreted in an idealized or overly formal sense, unless expressly so defined herein.

Hereinafter, various embodiments will be described with reference to the accompanying drawings.

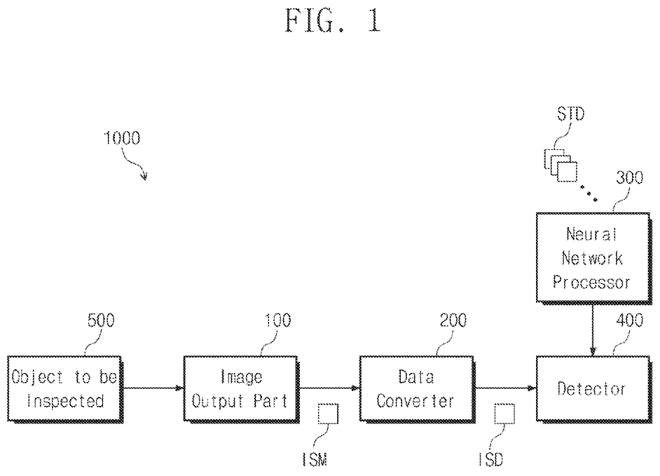

FIG. 1 is a schematic block diagram of an inspection device according to an embodiment.

Referring to FIG. 1, an inspection device 1000 may include an image output part 100, a data converter 200, a neural network processor 300, and a detector 400. The inspection device 1000 may correspond to at least one of various types of equipment for inspecting whether an inspection object 500 is defective.

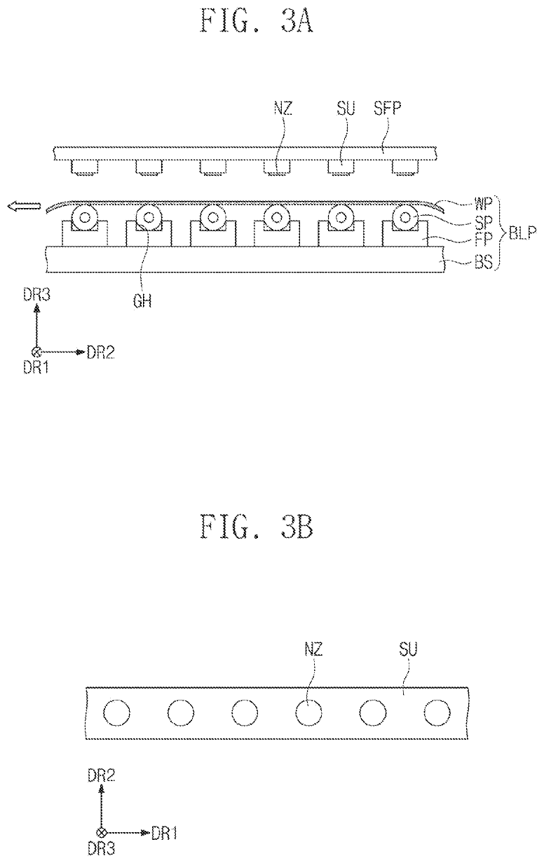

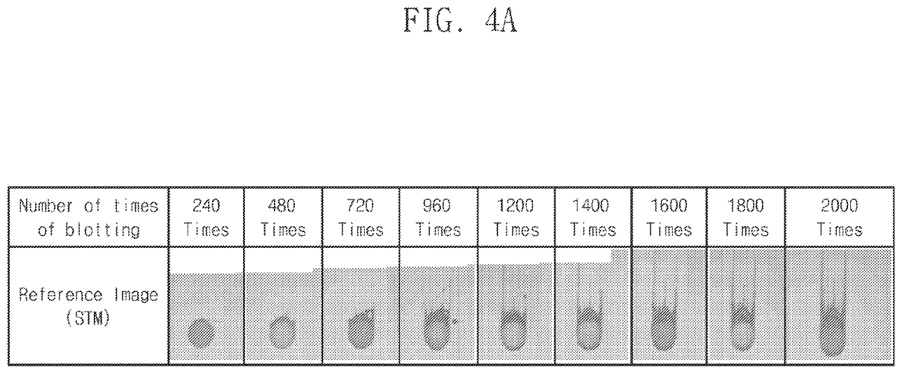

Referring to FIG. 1, the image output part 100 may output an inspection image ISM obtained by imaging the inspection object 500. An inspection image ISM may be obtained by emitting a beam from the image output part 100 or a separate imaging part to image, for instance, a cross-section of the inspection object 500. For example, the inspection image ISM may correspond to a cross-section of a nozzle among multiple nozzles NZ, such as a nozzle among the nozzles NZ illustrated in FIG. 3B. The inspection image ISM may be, for instance, a contrast image, such as a black image, a black and white image, a grayscale image, and/or the like, but embodiments are not limited to these example image types.

The data converter 200 may convert the inspection image ISM into inspection data ISD and output the inspection data ISD to, for instance, the detector 400. The inspection data ISD may be (or include) a data value corresponding to an average brightness value of the inspection image ISM. For example, in a case that the inspection image ISM is an 8-bit grayscale image, each of multiple pixels of the inspection image ISM may have a value of about 0 to about 255. The value of about 0 to about 255, which each pixel of the inspection image ISM may have, may be referred to as a brightness value. The inspection image ISM may be converted into grayscale data, and the grayscale data may be used to generate the inspection data ISD. The inspection data ISD may correspond to an average value of respective brightness values of the pixels of the inspection image ISM. For instance, the inspection data ISD may be at least one value obtained by dividing a sum of the respective brightness values of the pixels of the inspection image ISM by a total number of the pixels of the inspection image ISM. It is contemplated, however, that one or more additional or alternative types of data may be collected or determined using the inspection image ISM, such as a maximum brightness value, a minimum brightness value, etc. In some embodiments, the inspection image ISM may be one of multiple inspection images ISM of the inspection object 500, and the inspection data ISD may be aggregated over time and/or space to provide an average value of respective brightness values of the pixels of the inspection images ISM.

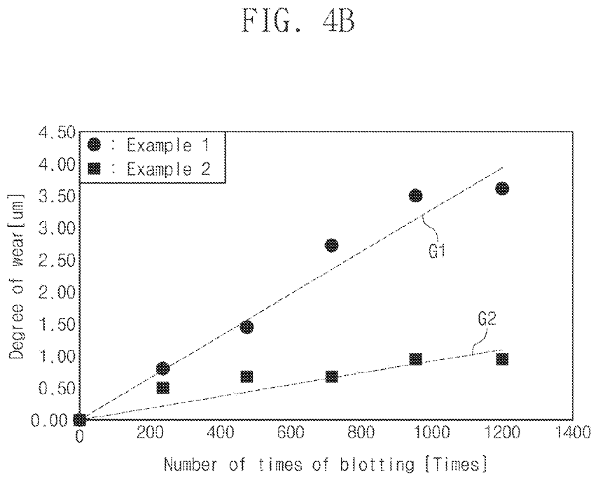

The neural network processor 300 may generate and store reference data STD. The reference data STD may be one or more data values corresponding to an average brightness value of each of multiple reference images STM (see FIG. 4A). The reference data STD may be a value obtained by dividing a sum of respective brightness values of pixels of each of the reference images STM by a total number of the pixels of each of the reference images STM. Although not illustrated, the reference images STM may be images obtained by imaging a single reference object, or may be obtained by imaging multiple reference objects. The reference data STD may be generated through at least one artificial neural network. A process of generating the reference data STD will be described later in more detail.

The detector 400 may compare the reference data STD stored in (or available to) the neural network processor 300 and the inspection data ISD provided from the data converter 200 to determine whether the inspection object 500 is defective. The inspection object 500 may include, for example, the nozzles NZ illustrated in FIG. 3B. As will become more apparent below, as a number of times of blotting increases, the nozzles NZ may be worn down, and a liquid-repellent film (or other coating or material) of one or more of (e.g., each of) the nozzles NZ may be damaged and may cause, at least in part. a defect in one or more ejection characteristics to occur in a case that a material (e.g., ink) is ejected from a corresponding nozzle among the nozzles NZ.

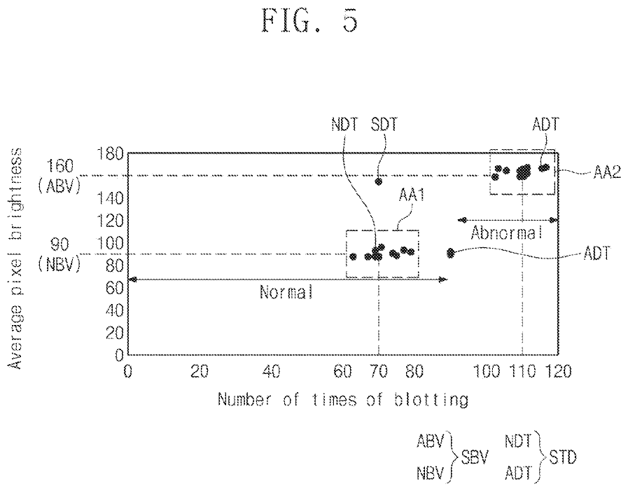

The detector 400 may determine the inspection data ISD to be defective or normal based on normal data NDT (see FIG. 5) and abnormal data ADT (see FIG. 5), which may be included in the reference data STD. The normal data NDT may be data generated using an inspection object 500 in which, for instance, the liquid-repellent film of the nozzle NZ is not damaged and is determined to be normal (or in a range of tolerance). The abnormal data ADT may be data generated using an inspection object 500 in which, for instance, the liquid-repellent film of the nozzle NZ is damaged and is determined to be defective (or not in a range of tolerance). In some embodiments, the normal data NDT and the abnormal data ADT may be used to determine whether the inspection object 500 is defective. As a result, a process of inspecting the inspection object 500 may be simplified, and the inspection device 1000 may be capable of performing reliable inspection.

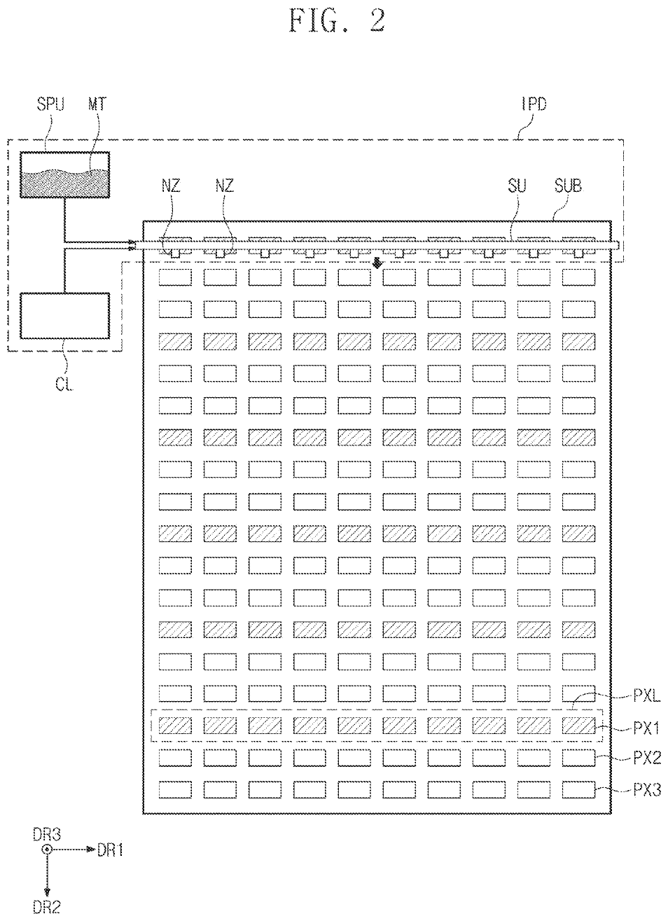

FIGS. 2, 3A, and 3B are schematic views for describing an inspection object according to an embodiment. FIG. 2 is a schematic plan view illustrating a spray device IPD according to an embodiment. FIG. 3A is a schematic cross-sectional view illustrating a spray portion SU, which is a part of the spray device IPD schematically illustrated in FIG. 2, and a blotter BLP that blots the spray portion SU according to an embodiment. FIG. 3B is a schematic cross-sectional view illustrating a portion to be blotted of the spray portion SU according to an embodiment. Hereinafter, the inspection object 500 described in association with FIG. 1 will be described with reference to FIGS. 2, 3A, and 3B.

Referring to FIG. 2, the spray device IPD may provide a target substrate SUB with a material MT, e.g., the spray device IPD may spray at least some of the material MT on the target substrate SUB. Hereinafter, the target substrate SUB provided with the material MT will be first described.

The target substrate SUB may have a rectangular plate shape parallel (or substantially parallel) to a plane defined by a first direction DR1 and a second direction DR2. Multiple pixels (e.g., first pixels PX1, second pixels PX2, and third pixels PX3) may be provided on the target substrate SUB. Hereinafter, the first pixels PX1, the second pixels PX2, and the third pixels PX3 may be collectively referred to as pixels PX1, PX2, and PX3. The pixels PX1, PX2 and PX3 may be disposed in the form of a matrix and may be arranged in the first direction DR1 and the second direction DR2. As mentioned, the pixels PX1, PX2 and PX3 may include one or more first pixels PX1, one or more second pixels PX2, and one or more third pixels PX3. The first pixels PX1, the second pixels PX2, and the third pixels PX3 may each be arranged to be parallel (or substantially parallel) in the first direction DR1. One (or a) pixel row PXL may be a row including the first pixels PX1, a row including the second pixels PX2, or a row including the third pixels PX3. Hereinafter, the first direction DR1 may be referred to as a row direction. The pixel row PXL including the first pixels PX1, the pixel row including the second pixels PX2, and the pixel row including the third pixels PX3 may be arranged (e.g., spaced apart from one another) and repeated in sequence in the second direction DR2. Hereinafter, the second direction DR2 may be referred to as a column direction. A third direction DR3 may be a direction perpendicular (or substantially perpendicular) to a plane defined by the first direction DR1 and the second direction DR2.

The first pixels PX1, the second pixels PX2, and the third pixels PX3, which may be disposed on the target substrate SUB, may be configured to display different colors from one another or a same color as one another. For example, the first pixels PX1 may display red colors, the second pixels PX2 may display green colors, and the third pixels PX3 may display blue colors. As used herein, a pixel that displays a color may be a pixel that emits light in a range of wavelengths associated with that color. In some embodiments, all of the first, second, and third pixels PX1, PX2 and PX3 may display, for instance, blue colors. However, these are just some examples, and the colors displayed by the first, second, and third pixels PX1, PX2 and PX3 are not limited to the foregoing examples.

The spray device IPD may include the spray portion SU, a supply (or material storage) SPU, and a controller CL. The supply SPU may be connected (e.g., fluidically connected) to the spray portion SU. The supply SPU may be connected (e.g., fluidically connected) to the spray portion SU, and may supply a material MT to be sprayed onto (or in a direction of) the target substrate SUB through the spray portion SU. The material MT supplied by the supply SPU may be an organic material. As an example, the organic material supplied to the spray portion SU by the supply SPU may be a light emitting material that emits light having one (or a) color.

An example in which the spray device IPD is used to spray the light emitting material is described, but a component capable of being formed using the spray device IPD is not limited to the foregoing example. For example, in a case that a display panel is a nano light emitting diode (LED) display panel, a light emitting layer of the nano LED display panel may be formed using the spray device IPD. The material MT may include a nano-sized LED device (e.g., a nano-sized LED chip or other structure) mixed (or dispersed) in a solvent (e.g., water). A nano-sized LED device may have a longitudinal dimension in a range of about 100 nm to about 10 μm, such as about 500 nm to about 5 μm. In some implementations, an aspect ratio of a nano-sized device may be in a range of about 1 to about 100, such as about 1.2 to about 50, e.g., about 1.5 to about 20, for instance about 1.5 to about 10. In some embodiments, a color filter and/or a wavelength converting pattern may be formed using the spray device IPD. The spray device IPD may be, for example, an inkjet printing device. However, embodiments are not limited to these examples, and the spray device IPD may be provided as various devices.

Although not illustrated, the spray device IPD may further include a transfer part that transfers (e.g., linearly translates or otherwise displaces) the spray portion SU. The spray portion SU may be moved by the transfer part in the second direction DR2 that is a column direction of the pixels PX1, PX2, and PX3. The spray portion SU may spray an organic material onto each of the pixel rows (e.g., pixel row PXL) of, for instance, the first pixels PX1 disposed in the first direction DR1, while moving in the second direction DR2. In some embodiments, the transferer may move the spray portion SU to a pixel row (such as pixel row PXL) to allow the spray portion SU to spray an organic material on those pixels of that pixel row before being moved to another pixel row.

The spray portion SU may be provided as one single component or device, but embodiments are not limited to this configuration. For example, the spray portion SU may be provided as multiple spray portions SU, such as schematically illustrated in FIG. 3A. In some implementations, the spray portions SU may be provided so as to cover the entirety (or substantial entirety) of the target substrate SUB. It is also contemplated that the spray portions SU may be provided so as to cover two or more pixel rows and/or two or pixel columns. The spray portion SU may be disposed above the target substrate SUB, and may spray the material MT onto (or in a general direction of) the target substrate SUB.

The spray portion SU may extend in the first direction DR1, which may be a row direction of, for instance, the first pixels PX1. FIG. 2 schematically illustrates an example in which the spray portion SU extends to overlap the first pixels PX1 arranged in the first direction DR1.

The spray portion SU may include multiple nozzles NZ. Hereinafter, the nozzles NZ may be collectively or individually referred to as a nozzle NZ or the nozzles NZ. As an example, FIG. 2 schematically illustrates one (or a) nozzle NZ for each of the first pixels PX1 in the first direction DR1, and ten nozzles NZ in total. However, embodiments are not limited to this example. For instance, the nozzles NZ may be disposed for each of the pixels PX1, PX2 and PX3, and in a number that corresponds to a number of the pixels PX1, PX2 and PX3. It is contemplated, however, that other configurations may be utilized.

The controller CL may control whether some nozzles NZ of a nozzle group among the nozzles NZ are activated. For instance, the controller CL may derive (or determine) an activation nozzle group from one or more nozzle groups, and may activate one or more of the nozzles NZ of the derived activation nozzle group. The controller CL may select which nozzles NZ are to be activated and which nozzles NZ are to be inactivated from among the nozzles NZ according to a design so that unnecessary (or at least undesired) spray can be prevented (or at least mitigated) to reduce manufacturing costs. This may also prevent (or at least mitigate) the material MT from being sprayed onto (or on) an incorrect (or unwanted) position.

FIG. 3A schematically illustrates multiple spray portions SU and a spray fixing part SFP provided to fix (or otherwise support) the spray portions SU, which are some components of the spray device IPD described in association with FIG. 2, and a blotter BLP that blots the spray portions SU according to some embodiments. The spray portions SU may be blotted by the blotter BLP.

Referring to FIGS. 3A and 3B, the spray portions SU may be fixed (or supported) at least partially beneath the spray fixing part SFP. The spray portions SU may include at least one nozzle NZ among the nozzles NZ, respectively. As an example, FIG. 3B schematically illustrates six nozzles NZ. A number of the nozzles NZ is not limited to this example, and the nozzles NZ may be in a range of one to six, or seven or more.

The nozzles NZ may have a same ejection amount or different ejection amounts from each other or at least one other nozzle NZ. For instance, respective amounts of material sprayed from the nozzles NZ may be equivalent or different from each other or at least one other nozzle NZ. This may be caused, at least in part, by an amount of the material MT delivered to the nozzles NZ, a design error, and/or the like. In addition, a rate of the material MT ejected from the nozzles NZ, and a position of the nozzles NZ that eject the material MT onto an application region, may also be different.

Referring to FIG. 3A again, the blotter BLP may be disposed below the spray portions SU. The blotter BLP may be a cleaning device that blots the nozzles NZ. For instance, the blotter BLP may clean an amount of the material MT remaining on and/or around one or more of (e.g., each of) the nozzles NZ. In some implementations, the blotter BLP may be utilized to clean potential contaminants (e.g., other material, debris, etc.) that may be on and/or around one or more of the nozzles NZ. The blotter BLP may include a base substrate BS, multiple fixing parts FP, multiple supply parts SP, and a wiper WP.

The fixing parts FP may be disposed on the base substrate BS. The fixing parts FP may be arranged in the second direction DR2. A distance in which the fixing parts FP are spaced from each other in the second direction DR2 may be the same, but embodiments are not limited to this example spacing. The fixing parts FP may be fixed (or otherwise supported) on the base substrate BS. A groove GH may be defined in each of the fixing parts FP.

The supply parts SP may be disposed on the fixing parts FP, respectively. For instance, each of the supply parts SP may be disposed in a corresponding groove among the grooves GH defined (or formed) in the fixing parts FP. The supply parts SP may be fixed to (or otherwise supported in association with) the fixing parts FP and disposed at least partially in the grooves GH, respectively.

The supply parts SP may be spaced apart from each other in the second direction DR2. A distance in which the supply parts SP may be spaced apart from each other in the second direction DR2 may be greater than a distance in which the fixing parts FP are spaced from each other in the second direction DR2. Each of the supply parts SP may have a circular shape in a view in the first direction DR1. Each of the supply parts SP may rotate around a rotary axis parallel (or substantially parallel) to the first direction DR1. Rotation directions of the supply parts SP may be the same as each other. For example, a rotation direction of the supply parts SP may be a counterclockwise direction about the rotary axis in a view in the first direction DR1. However, this is illustrative, and the rotation direction of the supply parts SP is not limited to this example.

The wiper WP may be disposed on the supply parts SP. The wiper WP may be fixed (or otherwise supported) to be in contact with the supply parts SP. As the supply parts SP rotate in the counterclockwise direction, the wiper WP may move in an opposite direction to the second direction DR2, but this is merely an example. Unlike what is schematically illustrated in FIG. 3A, the wiper WP may be in contact (e.g., direct contact) with the nozzles NZ. For instance, the spray portions SU may move in an opposite direction to the third direction DR3 so that the nozzles NZ are in contact (e.g., direct contact) with the wiper WP. The nozzles NZ may be cleaned by the wiper WP moving in the opposite direction of the second direction DR2. For example, the material MT may be sprayed onto the target substrate SUB as schematically illustrated in FIG. 2, and the material MT remaining on and/or around the nozzles NZ may be cleaned by the wiper WP abutting against the nozzles NZ and moving in the opposite direction of the second direction DR2. However, during this process, a coating, such as a liquid-repellent film, on and/or around at least one of the nozzles NZ may be damaged by, for instance, friction between the nozzles NZ and the wiper WP. Damage to one or more of the nozzles NZ, such as damage to the coating on one or more of the nozzles NZ, may cause, at least in part, a defect in an ejection characteristic to occur in a case that the nozzles NZ eject the material MT. It is noted that a defect associated with a first nozzle NZ among the nozzles NZ may not only cause, at least in part, differences in ejection characteristics of that first nozzle NZ, but may also cause, at least in part, differences in ejection characteristics of at least one second nozzle NZ among the nozzles NZ and/or one or more formation defects to occur in association with one or more of the pixels PX1, PX2, and PX3 formed using the first and/or second nozzles NZ or adjacent to at least one of the first and second nozzles NZ. Hereinafter, a number of times of cleaning the nozzles NZ by the wiper WP may be referred to as a number of times of blotting.

As illustrated in FIG. 3B, a cross-section of each of the nozzles NZ may have a circular shape in a plane parallel (or substantially parallel) to a plane defined by the first direction DR1 and the second direction DR2. Shapes and sizes of the respective nozzles NZ may be equivalent. However, embodiments are not limited to this example. For instance, a shape and/or a size of at least some of the nozzles NZ may be different from one or more other nozzles NZ among the nozzles NZ according to objects to be sprayed or otherwise formed on the target substrate SUB.

FIGS. 4A and 4B are views illustrating a degree of damage to a nozzle according to a number of times of blotting according to some embodiments. FIG. 4A is a table showing reference images STM of a reference object (e.g., one (or a) nozzle of the nozzles NZ described in association with FIG. 3B) according to a number of times of blotting according to some embodiments. FIG. 4B is a graph showing a degree of wear to reference objects (e.g., Examples 1 and 2) according to a number of times of blotting according to some embodiments.

Referring to FIG. 4A, the reference images STM may be different from each other according to a number of times of blotting. The reference image STM of a case in which a number of times of blotting is about 240 times has a shape which is almost like the shape of a nozzle NZ described in association with FIG. 3B and is a little stained. As used herein, a “stain” may be a fault that spoils an expected appearance of a reference image STM, such as extraneous spots, streaks, halos, and/or other artifacts in the reference image STM other than the expected shape of, for instance, the nozzle NZ. However, it may be confirmed that compared to the nozzle NZ described in association with FIG. 3B, the reference image STM in which a number of times of blotting is about 2,000 times is more abundantly stained, such as stained throughout. As the nozzle NZ is worn down, the stains may increase and/or intensify. For instance, it may be confirmed through the reference images STM that as a number of times of blotting increases, wear of (or to) the nozzle NZ may become more deleterious.

Referring to FIG. 4B, a first graph G1 showing a number of times (or cycles) of blotting and a degree of wear according to Example 1, and a second graph G2 showing a number of times of blotting (or cycles) and a degree of wear according to Example 2 may be confirmed. Examples 1 and 2 may each correspond to a nozzle NZ among the nozzles NZ described in association with FIG. 3B. It is noted, however, that the configuration of the nozzles NZ associated with Examples 1 and 2 are different from one another in the components that form the respective nozzles NZ.

In the graph, a number of times of blotting shown on the X axis is a number of times of cleaning the nozzles NZ (see FIG. 3B) by the wiper WP (see FIG. 3A), and assuming that a diameter of each of the nozzles NZ associated with Examples 1 and 2 is about 24 μm, a degree of wear shown on the Y axis is a length of a portion (or area) at which a liquid-repellent film (or membrane) on and/or around each of the nozzles NZ is damaged and may cause, at least in part, one or more of the stains to occur on an image, such as one of more of the images shown in FIG. 4A.

Referring to the first graph G1 representing Example 1, it may be confirmed that as a number of times of blotting increases, a degree of wear becomes greater and potentially more concerning in terms of, for example, formation of the material MT on the target substrate SUB in an intended manner. Even referring to the second graph G2 representing Example 2, it may be confirmed that as a number of times of blotting increases, a degree of wear also becomes greater and potentially more concerning. Referring to Examples 1 and 2, it may be confirmed that although there is a difference in rate of wear for different nozzle configurations, as a number of times of blotting increases, a degree of wear of the nozzles NZ becomes greater.

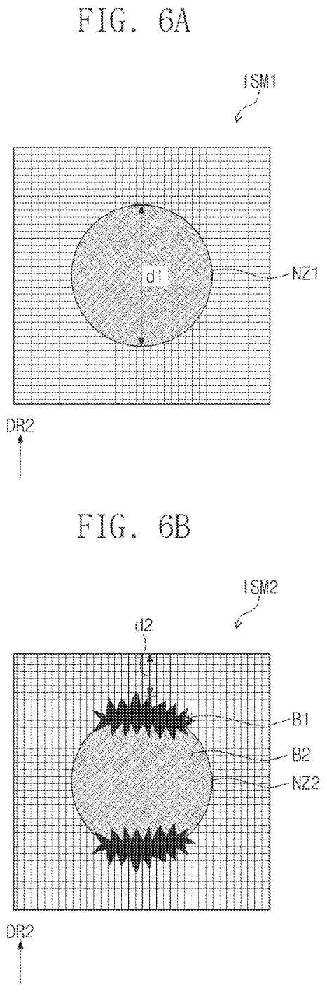

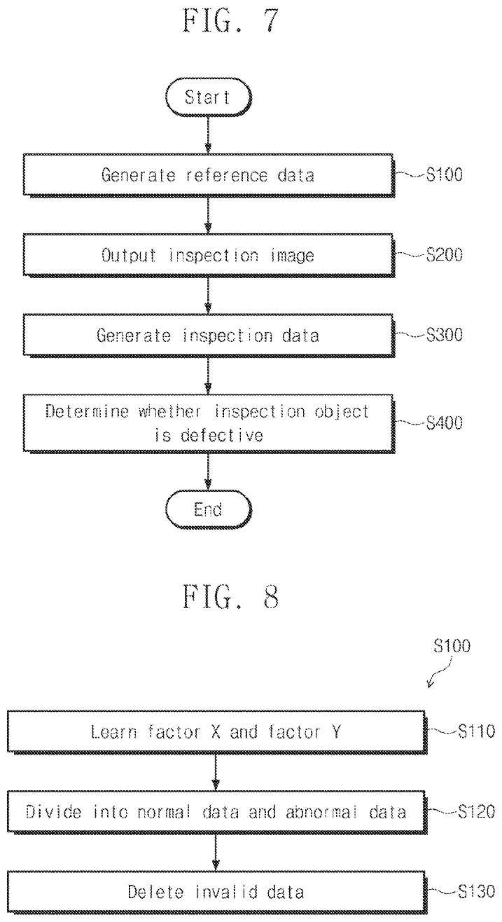

FIG. 5 is a graph illustrating reference data according to some embodiments. FIGS. 6A and 6B are schematic views illustrating inspection images according to some embodiments.

Referring to FIG. 5, in the graph, a number of times of blotting shown on the X axis is a number of times of cleaning the nozzles NZ (see FIG. 3B) by the wiper WP (see FIG. 3A), and an average pixel brightness value shown on the Y axis may correspond to a value obtained by converting, for example, a reference image STM (such as a reference image STM illustrated in FIG. 4A) into grayscale data, and dividing a sum of respective brightness values of pixels of the reference image STM by a total number of pixels of (or forming) the reference image STM.

The reference data STD may include normal data NDT (or first data) and abnormal data ADT (or second data). The normal data NDT may be disposed in a first area AA1, and the abnormal data ADT may be disposed in a second area AA2. The first area AA1 and the second area AA2 may be divided (or different from one another) based on a reference average brightness value SBV. For instance, the reference average brightness value SBV may include an average normal brightness value NBV and an average abnormal brightness value ABV, and the first area AA1 and the second area AA2 may be divided (or different from one another) according to a difference between the average normal brightness value NBV and the average abnormal brightness value ABV. For example, 30 (sigma) limits (e.g., three standard deviations from a mean) may be used to set an area (e.g., the first area AA1) corresponding to the average normal brightness value NBV, and 30 (sigma) limits may be used to set an area (e.g., the second area AA2) corresponding to the average abnormal brightness value ABV. Data disposed in the first area AA1 may be set to normal data NDT, and data disposed in the second area AA2 may be set to abnormal data ADT. The average normal brightness value NBV is an average brightness value obtained by converting the reference image STM (see FIG. 4B) corresponding to a normal nozzle, which is not worn down, into grayscale data, and is about 90. The average abnormal brightness value ABV is an average brightness value obtained by converting the reference image STM (see FIG. 4B) corresponding to a defective nozzle, which is worn down, into grayscale data, and is about 160. The 30 (sigma) limits for the first area AA1 may be determined with respect to a distribution of data points around the average normal brightness value NBV, and the 30 (sigma) limits for the second area AA2 may be determined with respect to data points around the average abnormal brightness value ABV.

Data outside the first area AA1 and the second area AA2 may be defined as invalid data SDT. For instance, the invalid data SDT may be data that is not included in the normal data NDT, nor the abnormal data ADT, and is not included in the reference data STD. The invalid data SDT may be deleted (or omitted).

According to an embodiment, the normal data NDT, the abnormal data ADT, and the invalid data SDT may be generated through, for instance, unsupervised learning of at least one machine learning model. It is noted that an unsupervised machine learning model may be given unlabeled data and allowed to discover patterns and insights in the data without explicit guidance or instruction. Representative examples of the unsupervised learning include clustering and unsupervised transformation. Clustering is an unsupervised learning technique in which unlabeled data points are grouped based on similarity and differences amongst the unlabeled data points. Unsupervised transformations utilize algorithms that generate one or more new representations of unlabeled data that may be more readily comprehensible to humans and/or other machine learning algorithms than an original representation of the unlabeled data. In some embodiments, unsupervised transformations may utilize the unlabeled data to discover one or more characteristic components that “make up” the unlabeled data. Even in instances that unsupervised learning does not give correct answer data, something meaningful can still be extracted from the unlabeled data. In the neural network processor 300 (see FIG. 1) according to an embodiment, clustering in which relationships between input data are identified to group data similar to each other may be used to generate the normal data NDT, the abnormal data ADT, and the invalid data SDT. In some implementations, unsupervised transforms of the data may be used to augment or supplant the generation of the normal data NDT, the abnormal data ADT, and the invalid data SDT.

Referring to FIGS. 6A and 6B, a first inspection image ISM1 is a schematic image corresponding to a first nozzle NZ1, and a second inspection image ISM2 is a schematic image corresponding to a second nozzle NZ2. Each of the first inspection image ISM1 and the second inspection image ISM2 may be represented by pixels. Each of the pixels represented in the first inspection image ISM1 may have a brightness value of about 0 to about 255. In each pixel, a bright portion may be set to be close to about 0, and a dark portion may be set to be close to about 255. In some implementations, the bright portion with relatively high brightness may be set to be close to about 0, and the dark portion with relatively low brightness may be set to be close to about 255.

Each of the first inspection image ISM1 and the second inspection image ISM2 may have an average brightness value. The average brightness value of the first inspection image ISM1 may be defined (or determined) as a value obtained by dividing a sum of respective brightness values of each of the pixels included in the first inspection image ISM1 by a number of the pixels included in the first inspection image ISM1. The average brightness value of the second inspection image ISM2 may be defined (or determined) as a value obtained by dividing a sum of respective brightness values of each of the pixels included in the second inspection image ISM2 by a number of the pixels included in the second inspection image ISM2. According to an embodiment, the average brightness value of the first inspection image ISM1 may be about 90, and the average brightness value of the second inspection image ISM2 may be about 160.

A cross-section of each of the first nozzle NZ1 and the second nozzle NZ2 in a plane parallel (or substantially parallel) to a plane defined by the first direction DR1 and the second direction DR2 may have a circular shape. A diameter d1 of the first nozzle NZ1 may be about 24 μm. A diameter of the second nozzle NZ2 may also be about 24 μm. As an example, the second nozzle NZ2 may be an image after blotting of the first nozzle NZ1 a number of times.

Referring to FIG. 6B, the second inspection image ISM2 may include a first portion B1 at which the second nozzle NZ2 is worn down, and a second portion B2 at which the second nozzle NZ2 is not worn down. The first portion B1 at which the second nozzle NZ2 is worn down may be formed on, for instance, each of a first (e.g., an upper) end and a second (e.g., lower) end of the second inspection image ISM2 relative to, for instance, the second direction DR2. As described with reference to FIGS. 3A and 3B, the nozzles NZ may be blotted by the wiper WP moving in the opposite direction to the second direction DR2. As a result, a coating, such as a liquid-repellent film or membrane, on and/or around each of the nozzles NZ in the second direction DR2 may be damaged. For instance, at least because of the blotting by the wiper WP, the first portion B1 may be formed on each of the first end and the second end of the second inspection image ISM2 of the second nozzle NZ2. For example, a spaced (or shortest) distance d2 between a top surface (or edge) of the second inspection image ISM2 and the first portion B1 may be in a range of about 4 μm to about 5 μm. The spaced distance d2, however, may vary depending on the initial configuration of the second nozzle NZ2, e.g., the initial configuration of the first nozzle NZ1.

The first portion B1 at which the second nozzle NZ2 is worn down may have a brightness value greater than a brightness value of the second portion B2 at which the second nozzle NZ2 is not worn down. For instance, an average brightness value of the first portion B1 may be greater than an average brightness value of the second portion B2. As a result, the average brightness value of the second inspection image ISM2 may be about 160, which is greater than about 90, which is the average brightness value of the first inspection image ISM1.

Referring to FIGS. 5, 6A, and 6B, the average brightness value of the first inspection image ISM1 is about 90 and may be determined to be normal as corresponding to the normal data NDT, and the average brightness value of the second inspection image ISM2 is about 160 and may be determined to be abnormal as corresponding to the abnormal data ADT. For instance, using the first and second inspection images ISM1 and ISM2 obtained by imaging the inspection object 500 (see FIG. 1), it may be readily and accurately determined whether the inspection object 500 is defective. As a result, a process of inspecting the inspection object 500 may be simplified, and the inspection device 1000 (see FIG. 1) may be capable of performing reliable inspection.

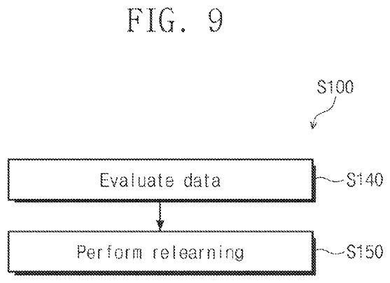

FIGS. 7 to 9 are flowcharts of an inspection method according to some embodiments. Hereinafter, the inspection method according to some embodiments will be described with reference to FIGS. 1 to 9.

Referring to FIGS. 1 to 9, a neural network processor 300 may generate reference data STD (S100). The reference data STD may correspond to an average brightness value of reference images STM obtained by imaging a reference object (e.g., one of the nozzles NZ described in association with FIG. 3B) through at least one artificial neural network.

According to an embodiment, the generating of the reference data STD (S100) may include learning a correlation between a factor X including a number of times of blotting of the reference objects and a factor Y including an average brightness value of the reference images STM (S110), dividing (or categorizing) the reference data STD into normal data NDT and abnormal data ADT based on a reference average brightness value SBV (S120), and deleting invalid data SDT that is not included in either the normal data NDT nor the abnormal data ADT (S130).

Unsupervised learning that is one type of machine learning may be used as a method for generating the reference data STD according to an embodiment. The unsupervised learning may include learning a correlation between the factor X and the factor Y. The factor Y may be a component that is not dependent on the factor X, and the reference data STD according to an embodiment may be generated by learning a correlation with the factor Y through an analysis method for the factor X.

The factor X corresponds to a number of times of blotting, and the factor Y corresponds to an average brightness value of the reference images STM. The factor X may further include an ejection accuracy of the reference object (e.g., the nozzles NZ described in association with FIG. 3B), an ejection amount of a sprayed material of the reference object, and an ejection rate of the sprayed material. For instance, the reference data STD may be generated through a correlation between a number of times of blotting, an ejection accuracy of the nozzles NZ, an ejection amount of the sprayed material of the nozzles NZ, an ejection rate of the sprayed material, and an average brightness value of the reference images STM (e.g., a degree of wear of the nozzles NZ). The factor Y may further include pulsatile waveforms (or other flow parameters) before and after driving the nozzles NZ. In some implementations, the pulsatile waveforms may correspond to variances in applied voltage (or other control signal) utilized to expand the nozzles NZ, a first delay for pressure wave propagation, compression of the material to be ejected from the nozzles NZ, a second delay for pressure wave propagation, and nozzle retraction to an initial or less expanded state as part of ejecting material from the nozzles NZ. In some embodiments, the factor Y may include only the pulsatile waveforms before and after driving the nozzles NZ.

The reference data STD may be divided (or categorized) into the normal data NDT and the abnormal data ADT. The normal data NDT may be divided (or categorized) according to the reference average brightness value SBV. For instance, as schematically illustrated in FIG. 5, the reference average brightness value SBV may include an average normal brightness value NBV and an average abnormal brightness value ABV, and a first area AA1 and a second area AA2 may be divided (or established) according to the average normal brightness value NBV and the average abnormal brightness value ABV. For example, 30 (sigma) limits may be used to set the first area AA1 corresponding to the average normal brightness value NBV, and 36 (sigma) limits may be used to set the second area AA2 corresponding to the average abnormal brightness value ABV. Data disposed in the first area AA1 may be set as the normal data NDT, and data disposed in the second area AA2 may be set as the abnormal data ADT. Data outside the first area AA1 and the second area AA2 may be defined as invalid data SDT. The invalid data SDT may be data that is not included in the normal data NDT nor the abnormal data ADT, and may also not be included in the reference data STD. The invalid data SDT may be deleted (S130) after (or as part of) the reference data STD being divided into the normal data NDT and the abnormal data ADT.

Outputting an inspection image ISM of an inspection object 500 (S200) may be performed. For instance, the inspection image ISM of the inspection object 500 may be output after the generating of the reference data STD (S100). The inspection image ISM may be generated and output through, for instance, emitting a beam from an image output part 100 or a separate imaging part to image a cross-section of the inspection object 500. In some implementations, the beam may be at least one of an acoustic beam, an optical beam, an x-ray beam, an electron beam, a neutron beam, a proton beam, and/or any other suitable beam (or imaging modality) for non-destructively imaging a cross-section of the inspection object 500.

Converting the inspection image ISM into grayscale data and using the grayscale data to generate the inspection data ISD (S300) may be performed after (or as a part of) the outputting of the inspection image ISM (S200). The inspection data ISD may be a data value corresponding to an average brightness value of the inspection image ISM. For example, in a case that the inspection image ISM is an 8-bit grayscale image, each pixel of the inspection image ISM may have a value in a range of about 0 to about 255. In some embodiments, the value in a range of about 0 to about 255, which each pixel of the inspection image ISM may have, may be referred to as a brightness value. The inspection image ISM may be converted into grayscale data, and the grayscale data may be used to generate the inspection data ISD. The inspection data ISD may correspond to an average value of respective brightness values of the pixels of the inspection image ISM. For instance, the inspection data ISD may be generated through dividing a sum of respective brightness values of the pixels of the inspection image ISM by a total number of the pixels of the inspection image ISM.

Comparing the reference data STD and the inspection data ISD to determine whether the inspection object 500 is defective (S400) may be performed utilizing the inspection data ISD generated using the inspection image ISM (S300). Using the stored reference data STD, the inspection method according to an embodiment may readily and accurately determine whether the inspection object 500 is defective through the imaging of the inspection object 500. As a result, a process of inspecting the inspection object 500 (e.g., a process of determining whether the inspection object 500 is defective) may be simplified.

According to an embodiment, the generating of the reference data STD (S100) may further include a data evaluating step of evaluating accuracy of the average brightness value of the reference images STM and a number of times of blotting of the reference objects (S140), and a step of relearning the factors X and Y (S150). The data evaluating step (S140) and the relearning step (S150) may be referred to as an optimization step. The data evaluating step (S140) may correspond to a reliability test on whether the inspection object 500 is defective. For instance, in the data evaluating step (S140), determining whether it is capable of being detected whether the inspection object 500 is defective may be performed through the stored reference data STD. If whether the inspection object 500 is defective is not detected through the stored reference data STD in the data evaluating step (S140), the factor X may further include ejection accuracy of the reference object (e.g., the nozzles NZ described in association with FIG. 3B), an ejection amount of a sprayed material of the reference object, and an ejection rate of the sprayed material in addition to a number of times of blotting to perform the step of relearning the factors X and Y (S150). For instance, the step of relearning the factors X and Y (S150) may be a step of learning a correlation between a number of times of blotting, an ejection accuracy of the nozzles NZ, an ejection amount of the sprayed material of the nozzles NZ, an ejection rate of the sprayed material, and an average brightness value of the reference images STM (e.g., a degree of wear of the nozzles NZ). As such, an even more reliable inspection method may be provided through the data evaluating step (S140) and the relearning step (S150).

An inspection device according to some embodiments may compare stored (e.g., previously stored) reference data and inspection data of an inspection object to readily and accurately determine whether the inspection object is defective. As a result, a process of inspecting the inspection object may be simplified, and the inspection device may be capable of performing reliable inspection.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatuses of the disclosed embodiments. Accordingly, embodiments are to be considered illustrative and not as restrictive, and embodiments are not to be limited to the details given herein.

What is claimed is:

1. An inspection device comprising:
a data converter configured to:
receive an inspection image of an inspection object;
convert the inspection image into grayscale data; and
use the grayscale data to generate inspection data corresponding to an average brightness value of the inspection image;
a neural network processor configured to generate reference data corresponding to average brightness values of reference images of reference objects through an artificial neural network; and
a detector configured to determine whether the inspection object is defective based on a comparison of the inspection data with the reference data.

2. The inspection device of claim 1, wherein
the neural network processor is configured to generate, through the artificial neural network, the reference data by learning a correlation between a first factor and a second factor,
the first factor comprises a number of times of blotting of the reference objects, and
the second factor comprises the average brightness values of the reference images.

3. The inspection device of claim 2, wherein each of the average brightness values of the reference images is proportional to the number of times of blotting of a corresponding reference object among the reference objects.

4. The inspection device of claim 3, wherein the reference data comprises first data and second data categorized based on one or more reference average brightness values.

5. The inspection device of claim 4, wherein the detector is configured to determine that the inspection object is defective based on the inspection data being in a range of the second data and outside a range of the first data.

6. The inspection device of claim 2, wherein
each of the inspection object and the reference objects comprises a nozzle, and
each of the inspection image and the reference images is a cross-sectional image of a corresponding nozzle among the nozzles of the inspection object and the reference objects.

7. The inspection device of claim 6, wherein the inspection image comprises:
a first portion at which the nozzle of the inspection object is worn down; and
a second portion at which the nozzle of the inspection object is not worn down.

8. The inspection device of claim 7, wherein an average brightness value of the first portion is greater than an average brightness value of the second portion.

9. The inspection device of claim 1, further comprising:
an imaging device configured to non-destructively image a cross-section of the inspection object to generate the inspection image and to transmit the inspection image to the data converter.

10. The inspection device of claim 6, wherein the first factor further comprises ejection accuracy of the nozzles of the reference objects, ejection amounts of a sprayed material from the nozzles of the reference objects, and ejection rates of the sprayed material from the nozzles of the reference objects.

11. The inspection device of claim 1, wherein the artificial neural network is an unsupervised artificial neural network.

12. An inspection method comprising:
generating, using an artificial neural network, reference data corresponding to average brightness values of reference images of reference objects;
receiving an inspection image of an inspection object;
converting the inspection image into grayscale data;
generating, using the grayscale data, inspection data corresponding to an average brightness value of the inspection image; and
determining whether the inspection object is defective based on a comparison of the inspection data with the reference data.

13. The inspection method of claim 12, wherein generating the reference data comprises:
learning each of a first factor comprising a number of times of blotting of the reference objects, a second factor comprising the average brightness values of the reference images, and a correlation between the first factor and the second factor; and
categorizing the reference data into at least first data and second data based on one or more reference average brightness values.

14. The inspection method of claim 13, wherein generating the reference data further comprises excluding invalid data not categorized as part of the first data nor the second data.

15. The inspection method of claim 13, wherein each of the average brightness values of the reference images is proportional to the number of times of blotting of a corresponding reference object among the reference objects.

16. The inspection method of claim 13, wherein generating the reference data further comprises evaluating accuracy of learning each of the average brightness values of the reference images, the number of times of blotting of the reference objects, and the correlation between the first factor and the second factor based on a result of the determining.

17. The inspection method of claim 16, wherein
each of the reference objects is a nozzle,
each of the reference images is a cross-sectional image of a corresponding nozzle among the nozzles, and
the first factor further comprises ejection accuracy of the nozzles, ejection amounts of a sprayed material from the nozzles, and ejection rates of the sprayed material from the nozzles.

18. The inspection method of claim 17, wherein generating the reference data further comprises relearning the first factor, the second factor, and the correlation utilizing a result of the evaluating.

19. The inspection method of claim 13, wherein determining that the inspection object is defective comprises determining that the inspection data is in a range of the second data and outside a range of the first data.

20. The inspection method of claim 13, wherein the learning is unsupervised learning.
